(19) United States
(12) Patent Application Publication
(10) Pub. No.: US 2002/0160642 A1
(43) Pub. Date: Oct. 31, 2002

(54) Flex cable connection system comprising a spring housing

(76) Inventors: Friedrich Bach, Lauf An Der Pegnitz (DE); Michael Hopf, Nurnberg (DE); Robert Janitschke, Nurnberg (DE)

Correspondence Address: PERMAN & GREEN, 425 POST ROAD, FAIRFIELD, CT, 06824, US

(21) Appl. No.: 10/108,800

(22) Filed: Mar. 27, 2002

(30) Foreign Application Priority Data
Mar. 28, 2001 (DE) 10115283

(51) Int. Cl. H01R 13/62

(52) U.S. Cl. 439/329

(57) ABSTRACT

The invention relates to a connection system for flexible flat strip cables (1a,1b) with parallel strip conductors lying at a distance from one another which are bared in the contact area (4), with a first housing part (2a) on whose floor (3) is fastened a principal flexible flat strip cable (12a) and a second housing part (2b) in which a branch flexible flat strip cable is fixed, with flexible tongues (5) which press the bared area of the branch flexible flat strip cable (1b), with the housing parts (2a,2b) in the inserted state, against the bared area of the principal flexible flat strip cable (1a).

The present invention relates to a connection system for flexible flat strip cables comprising parallel strip conductors lying at a distance from one another and each bared in an area of contact. The connection system has a two-part housing, which can be clipped shut and in which connection takes place between a main flat strip cable and a branch flat strip cable.

Such flat strip cables are used in vehicle multiplex systems, where, for example, they are to be led from a ring circuit, which carries current and signals on various strip conductors, to individual consuming points or sensors and similar branch conductors which also consist of flat strip cables. There is a requirement for a maximally flexible and easily handled connection system, whereby the said branches can be introduced at any point of the main flat strip conductor.

It is, accordingly, the purpose of the present invention to provide a connection system for flexible flat strip cables, which can be introduced and rapidly and easily fitted at any point of a flexible flat strip cable.

This purpose is reached according to the Claims

The characteristics of preferred embodiments are described in the subsidiary Claims.

The present invention is based on the idea of fitting a two-part clip on the principal flat strip conductor, where in the case of previously appropriately bared contact areas, a part of the clip already contains the end of a branch connection and the electrical connection is established by means of the mutual insertion of the two parts onto the principal flat strip cable and the pressing of the respective contact areas into one another.

The invention is explained below in greater detail by means of the description of an embodiment and by referring to diagrams.

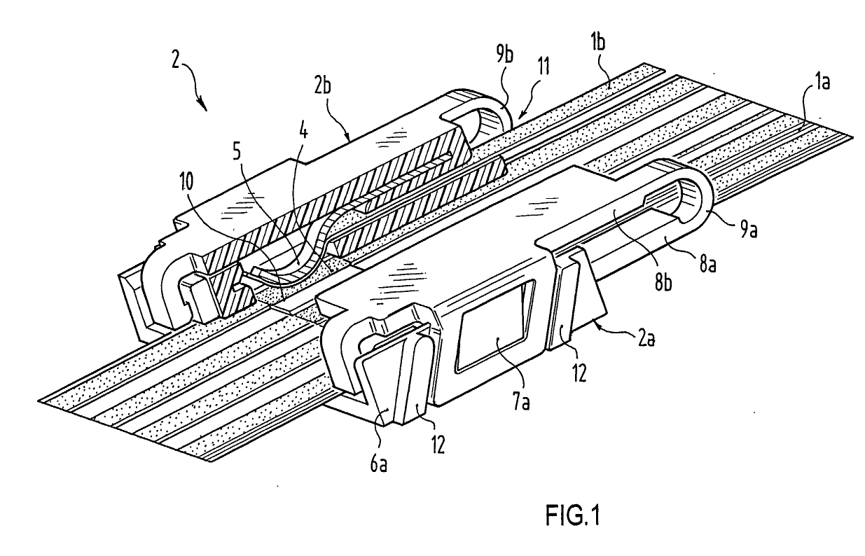

FIG. 1 shows in perspective a partial section view of an embodiment of the connection system according to the invention ; and

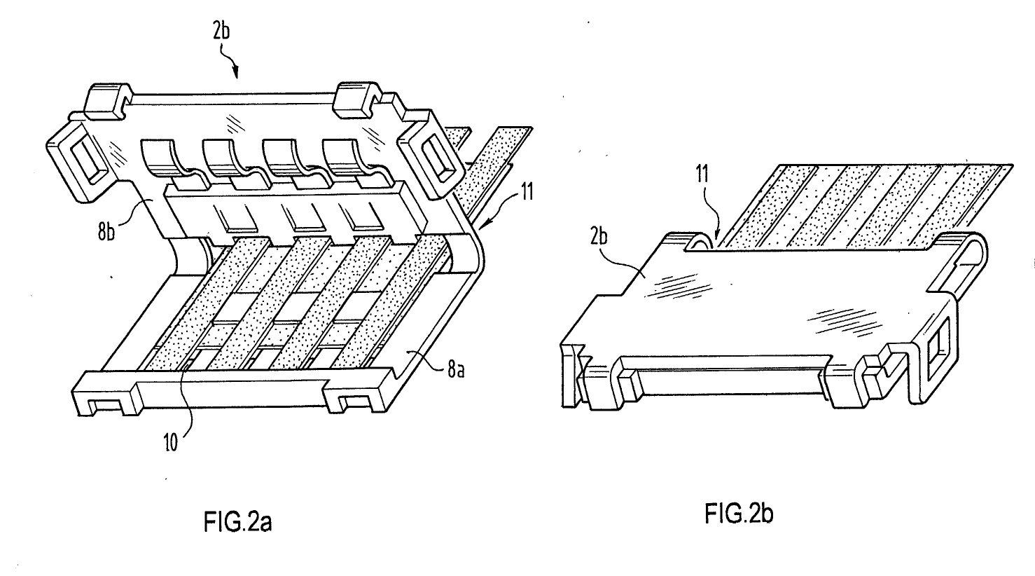

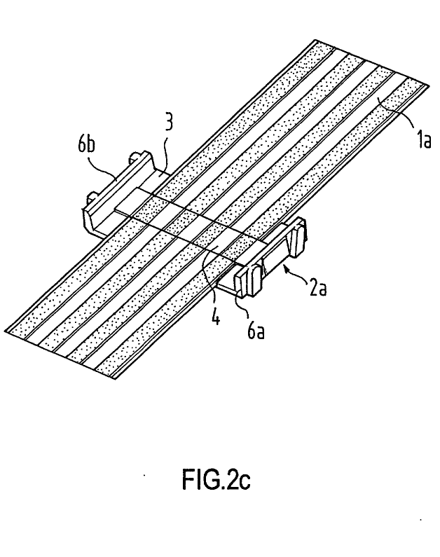

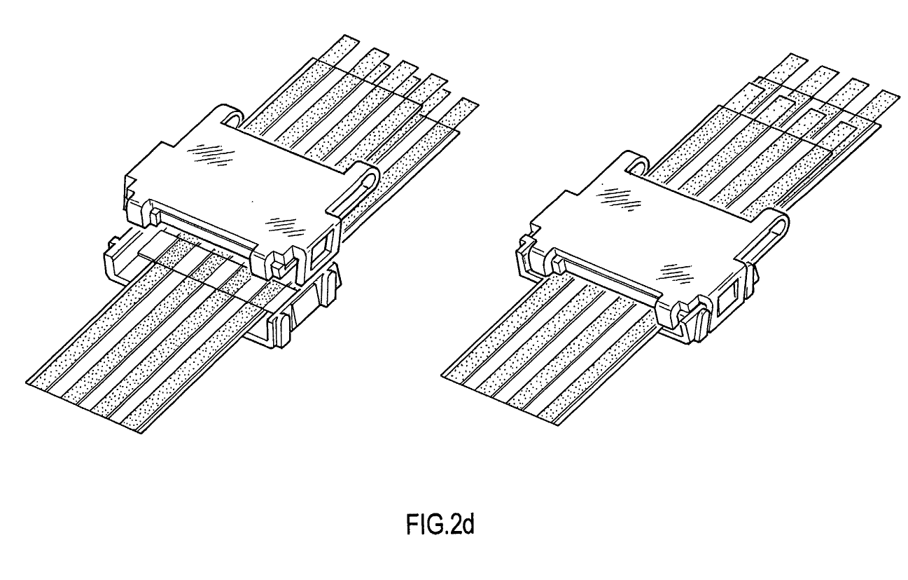

FIG. 2a to 2d show the process of assembly of the connection system according to the invention.

FIG. 1 shows a principal flexible flat strip cable 1a, on which is inserted the connection system according to the invention with an end of a branch flexible flat strip cable 1b. The connection system has a housing 2 with a lower first housing part 2a and an upper housing part 2b. The lower housing part 2a, which is shown separately in FIG. 2c, has a floor 3 with catch stops (not shown) which snap into recesses provided in the flat strip cable la and so exactly fix the position of the flat strip cable la in relation to the lower housing part 2a, whereby the bared contact areas 4 are also exactly fixed. The lower housing part 2a also has two side walls 6a, 6b opposite one another fitted with means of locking for the clipping on of the second housing part 2b. The second housing part 2b has a lower portion 8a and an upper portion 8b which are linked together by bendable bridges 9a,9b. An end of the branch flat strip cable into the second housing part 2b is passed between the connection bridges 9a,9b, until its reaches its front edge. The contact areas of the branch flat strip cable 1b which are also bared, lie above an opening 10 in the lower portion 8a of the second housing part 2b. The upper portion 8b is swung onto the lower portion 8a via the connection bridges 9a,9b and the second housing part is locked with the first housing part by snapping into the latter. The upper portion has a flexible tongue 5, whose free end is arc-shaped and whose convexity penetrates elastically into the contact area of the branch flat strip cable 1b through the opening 10 in the lower part 2b. The branch flat strip cable 1b is gripped between the upper portion 8b and the lower portion 8a and appropriately precisely adjusted for position in the recesses provided in the branch flat strip cable 1b by the catch stops. If the stopped end of the branch flat strip cable 1b of the second housing part 2b is now inserted into the first housing part, the contact areas of both the cables will lie exactly over one another and are pressed against one another by the free end of the flexible tongue 5.

FIG. 2 shows the process of assembly. According to FIG. 2a, the branch flat strip cable 1b is first inserted into the second housing part 2b, adjusted as described earlier and the second housing part 2b is closed as shown in FIG. 2b, whereby the upper part and the lower part lock together on the front face. Now, the closed upper housing part 2b is clipped on the housing part 2a on which the principal flat strip cable 1 is already fastened and the flexible tongues above the strip conductors press together the contact faces of the two cables and thus establish electrical contact.

As FIG. 1 shows, the clipping of the second housing part to the first housing part takes place by means of a bracket, which is arranged on a snap-in nose 7a located on the sidewall of the lower housing part 2a. The bracket is passed between two guide ribs 12, which are arranged diagonally to the vertical with respect to the flat strip cable 1a. This produces, during the insertion movement between the first mutual touch of the contact faces and attainment of the locked end-position, a wiping movement of the contact faces against one another in the direction of the axial cable, so that the contact faces can rid one other of oxide layers or soiling and the electrical transition resistance of this contact becomes smaller.

Thus, the connection system according to the invention represents a simple solution, which makes possible rapid assembly and a secure electrical connection.

The above description of an embodiment example only serves as an illustration of the present invention and is not to be understood as in any way limiting.

What is claimed is:

1. A connection system for flexible flat strip cables with parallel strip conductors placed at a distance from one another, which are bared in the contact area, comprising a first housing part on whose floor is fastened a principal flexible flat strip cable and a second housing part in which is fixed a branch flexible flat strip cable with flexible tongues which, in the inserted state of the housing parts, press the bared area of the branch flexible flat strip cable against the bared area of the principal flexible flat strip cable.

2. A connection system according to claim 1, wherein the first housing part has two sidewalls lying opposite one another, with means of locking for the removable fastening of the second housing part, which can be slackened.

3. A connection system according to claim 1, wherein the second housing part has a lower portion and an upper portion which is connected thereto by bendable bridges, where the upper portion has means of fixing an end of a branch flexible flat strip cable and an opening in the area of the contact areas on the flat strip cable and the upper portion is able to be swung and lowered over the bridges onto the lower portion and shaped so as to be able to be locked and has, above the opening in the lower portion, bulging flexible tongues above every strip conductor, which press the branch flat strip cable, through the opening, onto the principal flat strip cable.

4. A connection system according to claim 3, wherein the second housing part between the connecting bridges and between the upper portion and the lower portion, an insertion slot is provided and the exact position fixing of the branch cable which is firmly gripped between the upper portion and the lower portion, takes place via the catch stop in the lower portion and appropriately shaped recesses in the branch cable.

5. A connection system according to claim 3, wherein the flexible tongue is a flat steel spring whose free end is arc-shaped and penetrates into the opening and whose opposite end is cast or pressed into the upper portion.

6. A connection system according to claim 2, wherein the means of locking are formed on a housing portion via of a bracket on the other housing portion led between diagonal guide ribs, where a wiping effect occurs through the diagonal locking, on the contact areas which are to be pressed together.

7. A connection system according to claim 2, wherein the second housing part has a lower portion and an upper portion which is connected thereto by bendable bridges, where the upper portion has means of fixing an end of a branch flexible flat strip cable and an opening in the area of the contact areas on the flat strip cable and the upper portion is able to be swung and lowered over the bridges onto the lower portion and shaped so as to be able to be locked and has, above the opening in the lower portion, bulging flexible tongues above every strip conductor, which press the branch flat strip cable, through the opening, onto the principal flat strip cable.

8. A connection system according to claim 7, wherein the second housing part between the connecting bridges and between the upper portion and the lower portion, an insertion slot is provided and the exact position fixing of the branch cable which is firmly gripped between the upper portion and the lower portion, takes place via the catch stop in the lower portion and appropriately shaped recesses in the branch cable.

9. A connection system according to claim 7, wherein the flexible tongue is a flat steel spring whose free end is arc-shaped and penetrates into the opening and whose opposite end is cast or pressed into the upper portion.
